(19) United States
(12) Patent Application Publication
(10) Pub. No.: US 2026/0234782 A1
(43) Pub. Date: Aug. 13, 2026

(54) CERAMIC COATING

(71) Applicant: Tokamak Energy Ltd, Abingdon Oxfordshire (GB)

(72) Inventor: Sandeep Irukuvarghula, Abingdon Oxfordshire (GB)

(21) Appl. No.: 19/149,999

(22) PCT Filed: Jan. 23, 2024
(86) PCT No.: PCT/EP2024/051561

§ 371 Date: Jul. 22, 2025

(30) Foreign Application Priority Data
Jan. 23, 2023 (GB) 2300960.8

(51) Int. Cl. C23C 8/10; B22F 3/15; B22F 7/08; C23C 8/24; G21B 1/05; G21B 1/13

(52) U.S. Cl. CPC C23C 8/10; B22F 3/15; B22F 7/08; C23C 8/24; G21B 1/13; B22F 2301/20; B22F 2301/35; B22F 2998/10; G21B 1/057

(57) ABSTRACT

A method of producing a component, wherein the component comprises a body and a ceramic coating, the method comprising at least partially filling a receptacle with a powdered material; subjecting the receptacle to compressive pressure at a temperature and for a period of time sufficient to at least partially consolidate said powdered material to form the body of the component; and subjecting the receptacle to oxidising conditions, nitridising conditions and/or carburising conditions to thereby form the ceramic coating.

### FIELD OF THE INVENTION

The present invention relates to a method of producing a component having a ceramic coating, an apparatus comprising the component produced by that method, and use of that apparatus, in particular within a tritium breeder blanket.

### BACKGROUND

Tritium is a proposed fuel for fusion reactors. However, as it is a relatively short-lived isotope (a half-life of 12.3 years), existing fusion reactor designs require so-called “breeder” elements to ensure the amount of tritium remains at an acceptable level. There are many types of breeders known to the skilled reader, which primarily include lithium as the breeding element. For example, breeding elements include: liquid (or molten) lithium, lithium-containing ceramics, lithium-lead eutectic, molten lithium salts, lithium-containing intermetallics, ternary lithium alloys etc. Expected problems include corrosion of structural components of the reactor, magnetohydrodynamic (MHD) pressure drop when using liquid metal breeders, permeation of tritium into these structural components, or a combination of them.

For this reason, it has been proposed that the structural components of fusion reactors that come in contact with lithium-containing materials and/or tritium are coated with a ceramic layer (<100 μm). The material used for the coating varies depending on the breeder design but includes: alumina, silicon carbide, aluminium nitride, calcium oxide, erbium oxide, yttrium oxide, titanium carbide or nitride, zirconium carbide or the like. Such ceramic coatings provide a physical barrier for tritium permeation between the breeder and structural component as well as a resistive barrier to limit MHD pressure drop and corrosion rates. The coating is also compatible with the breeder material and, to an extent, resilient to physical and property degradation during its service (e.g., neutron irradiation).

Conventionally, the ceramic coatings are applied by (a) line-of-sight methods, such as chemical vapour deposition (CVD), plasma vapour deposition (PVD), magnetron sputtering etc. A problem with most of these methods is that they are unsuitable for coating complex surfaces (i.e., large and/or non-planar) and coated components cannot subsequently be joined and/or shaped without affecting the quality of the coating. Another problem is that ceramic coatings are vulnerable to localised failure (e.g., cracking, spalling etc.) due to their brittleness. More specifically, due to the mismatch in the coefficient of thermal expansion between the ceramic coating and the more ductile underlying structural material, high stresses develop where steep thermal gradients are present in the breeder blanket, which leads to the formation of cracks. This is also exacerbated by neutron irradiation. Regions of localised failure in the coating (e.g., a crack) act as tritium permeation “highways” into the structural components beneath and/or act as electrically conducting paths in case of liquid metal breeders, as well as regions of accelerated corrosion.

An improved method of producing a ceramic coating onto a component of more complex geometry, and an improved coating more robust to localised failure, in particular during operation, is therefore desirable.

### SUMMARY

According to a first aspect of the invention, there is provided a method of producing a component, wherein the component comprises a body and a ceramic coating, the method comprising: at least partially filling a receptacle with a powdered material; subjecting the receptacle to compressive pressure at a temperature and for a period of time sufficient to at least partially consolidate said powdered material to form the body of the component; and subjecting the receptacle to oxidising conditions, nitridising conditions and/or carburising conditions to thereby form the ceramic coating.

Optionally, the thickness of the ceramic coating formed by said oxidising, nitridising and/or carburising conditions is less than the thickness of the receptacle, thereby defining a cladding layer between said body and said ceramic coating. The cladding layer is an intermediate layer arranged between the body and the ceramic coating of the component. The cladding layer constitutes a part of the receptacle which is not transformed into a ceramic or remains substantially unaffected by the oxidising, nitridising or carburising conditions.

Optionally, the thickness of the receptacle is around 1 mm to 3 mm, and the thickness of the ceramic coating is around 5 to 15 μm. In some examples, the receptacle can be subject to acid leaching or pickling to reduce its thickness to 200 to 500 microns before said oxidising, nitridising and/or carburising step.

The ceramic coating may comprise an oxide, a nitride and/or a carbide of a metallic constituent present in the composition of the receptacle.

In some examples, the ceramic coating comprises a metal oxide, and the method further comprises: providing one or more elements, having a higher affinity for oxygen than a metal of the metal oxide, in the vicinity of said ceramic coating by: subjecting the ceramic coating to a carrier fluid comprising said one or more elements, whereby said step replaces said metal oxide in the ceramic coating with an oxide of said one or more elements.

The receptacle may be fabricated by an additive manufacturing method.

The packing density of the powdered material in the receptacle may be less than 70%. This can be achieved, for example, with a powdered material having a unimodal size distribution.

The compressive pressure may be isostatic, with the average isostatic pressure being in the range 50 to 150 MPa, the average temperature being in the range 1000 to 1300° C. and the period of time at said temperature and said pressure being in the range of 3 to 5 hours. These average isostatic pressures, average temperatures and period of time may result in dynamic grain recrystallization of the powdered material.

The powdered material may be produced by nitrogen or argon gas atomisation.

The powdered material may be a pre-alloyed powder comprising an alloy of Vanadium with Chromium and at least one of Titanium or Zirconium. For example, the pre-alloyed powder may comprise 4-5 wt % Chromium, 4-5 wt % Titanium, <0.2 wt % Yttrium, 89.8-91.8 wt % Vanadium. Alternatively, the powdered material may comprise any one of: ODS-steel, austenitic stainless steel or a reduced activation ferritic/martensitic steel.

The receptacle may comprise any one or more of: iron, chromium, aluminium, titanium, zirconium or an alloy thereof.

According to a second aspect of the invention, there is provided a component comprising a sintered body, a cladding layer surrounding the sintered body, and the ceramic coating surrounding the cladding layer, wherein, the ceramic coating comprises a metal oxide, a metal nitride and/or a metal carbide of a metal present in the cladding layer. The component may be a produced by the method according to the first aspect of the invention.

According to a third aspect of the invention, there is provided an apparatus comprising a component according to the second aspect, wherein, in use, the apparatus comprises a carrier fluid in contact with the ceramic coating, the carrier fluid comprising one or more carbon, nitrogen and/or oxygen containing gaseous molecules.

According to a fourth aspect of the invention, there is provided use of the component according to second aspect or the apparatus according to third aspect in a magnetic confinement plasma chamber.

According to a fifth aspect of the invention, there is provided a tokamak comprising a tritium breeder blanket, wherein the tritium breeder blanket comprises a component according to the second aspect.

The tritium breeder blanket may comprise a carrier fluid in contact with the ceramic coating, wherein the ceramic coating comprises a metal oxide and the carrier fluid comprises one or more elements, which have a higher affinity for oxygen than a metal of the metal oxide.

Optionally, the carrier fluid further comprises liquid lithium or lithium-lead eutectic, and wherein the one or more elements are erbium, yttrium and calcium dissolved in said carrier fluid at a concentration between 5 and 10 wt %.

In use, the tritium breeder blanket may comprise a carrier fluid in contact with the ceramic coating, the carrier fluid comprising one or more carbon, nitrogen and/or oxygen containing gaseous molecules. The gaseous molecules being any one or more of: nitrogen, nitrogen oxide, carbon monoxide, carbon dioxide, water vapour and oxygen and wherein, the carrier fluid further comprises any one of: a helium-hydrogen mixture; liquid lithium; and lead-lithium eutectic.

According to sixth aspect of the present invention, there is provided use of the component produced according to the method of the first aspect in an apparatus. The apparatus may be a magnetic confinement plasma chamber or a component part of a hydrogen (e.g., tritium) and/or liquid lithium transport system such as a pipe.

According to a seventh aspect of the present invention, there is provided a method of producing a component having a ceramic coating, the method comprising: at least partially filling a receptacle with a powdered material; subjecting the powdered material to compressive pressure at a temperature and for a period of time sufficient to at least partially consolidate said powdered material to form a body of the component; and transforming an external surface of the receptacle into a ceramic coating such that an untransformed layer of the receptacle remains between the body of the component and the ceramic coating. The ceramic coating provides a protective barrier to hydrogen, particularly tritium, for the body of the component. The untransformed layer enables self-healing of the ceramic coating in the event of cracks or other failures in the ceramic coating.

### BRIEF DESCRIPTION

Some embodiments of the invention will now be described by way of example only and with reference to the accompanying drawings, in which:

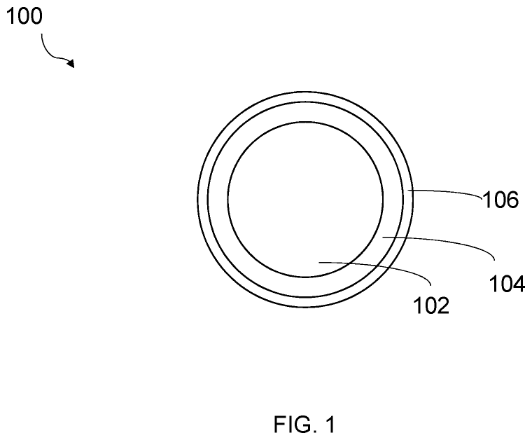

FIG. 1 is a schematic illustration of a component with a ceramic coating;

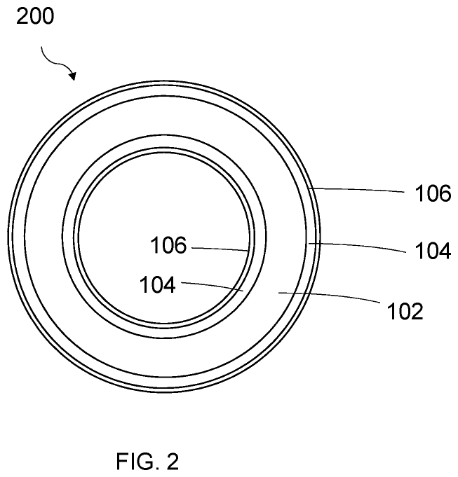

FIG. 2 is a schematic illustration of another component with a ceramic coating;

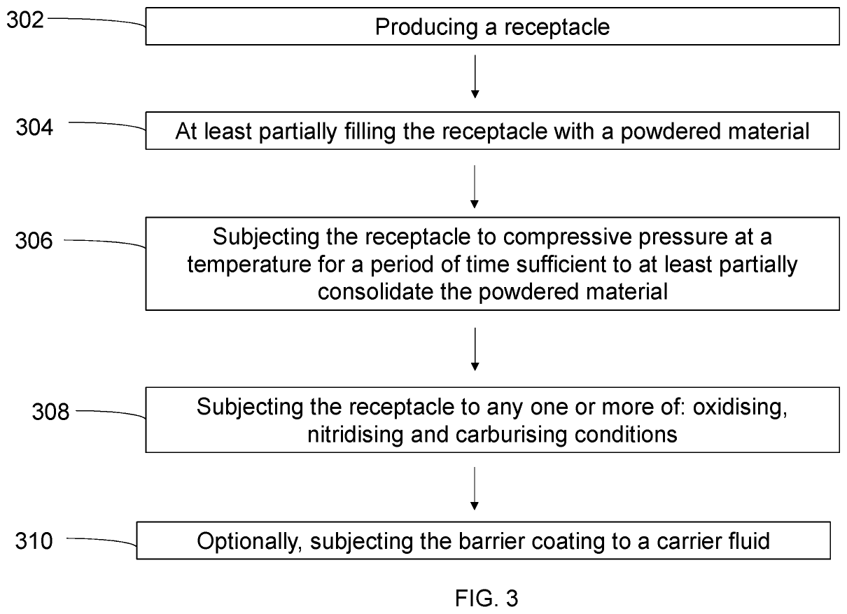

FIG. 3 is a method diagram; and

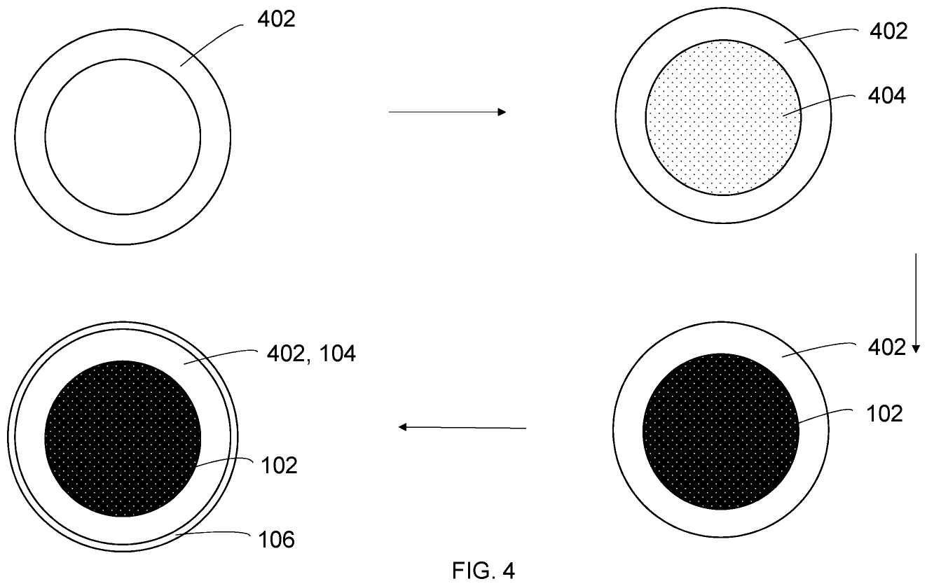

FIG. 4 is a schematic illustration of the component during fabrication.

### DETAILED DESCRIPTION

This disclosure proposes a method of producing a component having a ceramic coating. When used in a tritium breeder blanket, the ceramic coating functions: to limit tritium permeation; to limit corrosion of underlying structural components; and/or as an electrical insulator to reduce MHD pressure drop. The method is particularly advantageous for fabricating ceramic coatings on components of complex geometry, which cannot be applied using conventional line-of-sight techniques. Similarly, since the method involves integrated manufacturing of a net shape or near net shape component (which can be complex in shape) with a ceramic coating, assemblies (e.g., those of complex geometry) comprising an arrangement of these net shape or near net shape components can be made with fewer joints than when using components made by conventional methods, which are restricted to simpler shapes.

Referring to FIG. 1, a transverse cross section of a component 100, having a ceramic coating 106, is shown. The component 100 comprises: a body 102 surrounded by a cladding layer 104, which has a ceramic coating 106 on its exterior. The cladding layer 104 and body 102 are comprised from dissimilar metals or metallic alloys and are chemically bonded with one another via a peripheral interface. The ceramic coating 106 on the cladding layer 104 is a ceramic comprised from at least one of: a nitride, oxide, carbide. The ceramic may be a nitride, oxide, carbide of at least one metallic constituent contained in the composition of the cladding layer 104. Alternatively, or additionally, the ceramic may include a nitride, oxide, carbide of another metallic constituent (i.e., not present in the cladding layer 104).

In some examples, the component may not include a cladding layer 104. This might occur if the receptacle in step 208 is completely transformed into ceramic coating 106, leaving no cladding layer. The requirement that the component 100 comprises the cladding layer 104 is not essential in this regard.

The transverse-cross section in FIG. 1 is shown as being circular in the example of FIG. 1. The skilled reader will understand that the component 100 may have any other regular or even an irregular cross-section.

Turning to FIG. 2, a transverse cross-section of another component 200 in the form of a hollow tube is shown. The component comprises a body 102 with cladding 104 and ceramic coating layers 106 arranged on the radially inner and outer surface of the body portion 102. The tube is shown as circular in cross-section but other cross-sections are possible.

In some examples (not shown), the cladding layer 104 and ceramic coating 106 are provided on only one of the radially inner or radially outer surfaces of the body portion 102. A component 200 with a cladding and ceramic coating layer arranged on at least the radially inner surfaces are particularly useful as pipes, or other forms of receptacle, that are intended to transport, hold or otherwise be exposed to lithium or tritium (or other isotopes of hydrogen) containing material.

FIG. 3 shows a method to manufacture the component 100 shown in FIG. 1 is shown. The results of each step are depicted schematically in FIG. 4. The skilled reader will appreciate that the method can be applied in an analogous manner to make the component shown in FIG. 2. The principal differences are that the receptacle 402 defines an annular cavity for receiving the powdered material 404 and that the oxidising, carburising and nitridising conditions in step 308 may be applied to either one or both of the radially inner and outer surfaces of the receptacle 402 following step 306.

In step 302, a receptacle 402 is produced.

In step 304, the receptacle 402 is at least partially filled with a powdered material 404.

In step 306, the receptacle 402 is subject to isostatic pressure at a temperature and for a period of time sufficient to cause:
the metallic powder 404 contained within the metallic receptacle 402 to at least partially consolidate (i.e., densify by sintering) to form the body 102 of the component 100; and
the inwardly facing surface of the metallic receptacle 402 to bond with the body 102.

In optional step 307, the receptacle 402 may be subject to a heat treatment for a period of time. For example, heated until dynamic recrystallization of the body 102 of the component.

In step 308, the receptacle 402 is subjected to any one or more of: an oxidising, a nitridising, and a carburising environment, causing a ceramic coating 106 to form on at least the outwardly facing surface of the receptacle 402. The ceramic coating 106 that forms comprises an oxide, nitride and/or carbide of a metallic constituent present in the receptacle 402. The remaining receptacle, which is substantially unaffected by the oxidising, nitridising and carburising step, constitutes the cladding layer 104 in FIG. 1. The material composition of the receptacle, at step 302, and the cladding layer are substantially the same.

Optionally, in step 310, the ceramic coating 106 is subjected to a carrier fluid. The carrier fluid is used to transport one or more elements having a higher affinity for oxygen than the metal in the metal oxides present in the ceramic coating 106. These elements at least partially reduce the metallic oxides present in the ceramic coating 106 from step 308, replacing them with their oxides.

The steps described in FIG. 3 may be performed sequentially, concurrently or according to any other working order. For example, steps 306, 307 and/or 308 may be performed together.

Further details of the method in FIG. 3 are now described.

### Receptacle

The receptacle 402 may be produced by known additive manufacturing methods or by known subtractive methods. Suitable additive manufacturing methods include powder-based processing routes such as: direct metal laser sintering (DMLS), selective laser sintering (SLS), direct metal printing (DMP), Laser Powder Bed Fusion (LPBF), Electron Beam Melting (EBM), Electron Beam Additive Manufacturing (EBAM), Laser Engineered Net Shaping (LENS), Direct Metal Deposition (DMD), Selective Laser Melting (SLM), metal injection moulding (MIM) or the like.

The receptacle 402 shown in FIG. 4 is at least partially hollow, and has an opening at one of its ends. The receptacle is metallic. The as-produced receptacle is considered net or near-net shape, i.e., has a shape corresponding to the intended shape for the final component.

The receptacle 402 has a composition comprising at least one constituent that is capable of forming an oxide, nitride or carbide in an oxidising, nitridising or carburising environment. Example constituents include: iron, aluminium, chromium, titanium, and/or zirconium. In some examples, the receptacle is an alloy (e.g., FeCrAl, Fe—Ti). In some examples, the weight fraction of each of aluminium, titanium, zirconium and/or chromium is greater than 5%. Some of the alloys may include erbium and yttrium.

For components 100, 200 that are intended to be for structural components, the thickness of the receptacle, following the method in FIG. 3, is preferably less than the transverse extent of the hollow interior of the receptacle. This ensures that the mechanical strength of the component 100, 200 is dictated mainly by the mechanical properties of the material comprising the body 102, rather than the cladding 104 and/or the ceramic coating 106, which may in general be weaker. More specifically, the thickness of the receptacle is less than a fractional threshold relative to the transverse extent of the hollow portion of the receptacle. Specifically, the fraction is less than 0.25, more specifically less than 0.1, even more specifically less than 0.05. At sufficiently low fractions, the mechanical properties of the cladding and/or the ceramic coating layers can be ignored.

At the same time, the thickness of the receptacle is large enough to ensure that, during isostatic pressing in step 306, rupture and loss of powder does not occur. Generally speaking, this means the as-produced receptacle 402 in step 302 is at least 1 to 2 mm (or 1 to 3 mm) thick, unless, however, the overall thickness of the produced component 100, 200 is less than this.

Accordingly, in examples where the thickness of the receptacle is preferably minimal (e.g., less than 5% of the transverse extent of the hollow portion of the receptacle, as recited above), the receptacle 402 can initially be of greater fractional thickness (>5%) and, following step 306 reduced to appropriate thickness as desired (e.g., down to 200 to 500 microns by acid leaching, or, pickling).

### Powdered Material

The powdered material may be gas atomised. Example gases include nitrogen, argon (or other inert gases) and the like. The powdered material 404 has a distribution of powder sizes, which may include a plurality of peaks at different powder sizes, or only a single peak (unimodal). As the skilled reader knows, the powder size distribution affects the packing density of the powder during the filling in step 304, and the extent of deformation during the powder consolidation process in step 306. The packing density is defined as the volume taken by the powdered material divided by the volume of the hollow portion of the receptacle.

For powder distributions having a plurality of peaks (and which are spaced apart to allow smaller powder particles to reside within interstices between larger powder particles), at least partially filling in step 304 means: filling the receptacle 402 with powder at a high packing density—greater than 80%, more preferably 90%, even more preferably greater than 95%. Powdered material 404 with a higher packing density requires less consolidation to achieve its theoretical density. A result is that lower temperatures, lower pressures and/or less time spent at those conditions is required for powder consolidation in step 306.

For powder distributions having a single peak (or peaks that are not spaced apart enough to allow the smaller powder particles to reside within interstices between the larger powder particles), at least partially filling in step 304 means: filling the receptacle 404 with powder at a relatively low packing density, e.g., less than around 70%. Powdered material 404 with a lower packing density (e.g., less than around 70%) requires greater consolidation to achieve its theoretical density. A corollary is that the powdered material 404 is plastically deformed to a greater extent. The stored energy associated with this plastic deformation can result in dynamic recrystallization, which can improve the microstructure of the body 102 of component after powder consolidation. For example, grain size may be refined and impurities (e.g., in the form of oxides) at prior particle boundaries may be eliminated (more detail below).

Narrow powder size distributions (e.g., unimodal distributions) can be generated using sieving or other size sorting methods known to the skilled reader. As the packing density of the powder is less for narrower size distributions comparatively more plastic deformation occurs during consolidation step 306.

The inventors have realised that by reducing the packing density (e.g., to less than 75%, more specifically less than 70%), the plastic deformation induced in step 306 can be sufficiently large that dynamic recrystallization of some alloys can occur, in particular for austenitic steels and vanadium alloys. For vanadium alloys, this is a surprising result because the phenomenon of dynamic recrystallization is typically only observed for low to medium stacking fault energy materials (e.g., austenitic steels, nickel based alloys, copper etc.).

### Consolidation of the Powdered Material

Step 304 may further include closing the opening of the receptacle 402, e.g., by applying a fluid-tight seal to the open end of the receptacle, by crimping the open-end of the receptacle closed, or the like. This step is known to the skilled reader and ensures the powdered material is retained within the receptacle 402 during consolidation.

Preferably, following step 306, the density of the body 102 is greater than 90% of the theoretical density, more preferably greater than 95%, even more preferably greater than 99%. The theoretical density of the body 102 is the average density of the individual powder particles, absent voids or porosity. This value is known to the skilled reader.

The bond formed in step 306 between the metallic receptacle 402and body 102 may be a diffusion bond. Such a bond forms provided: at least one of the metal constituents of the receptacle 402is at least partially soluble in at least one of the metal constituents present in the powdered material 404/body 102, or vice versa; and the receptacle 402 is held at an elevated temperature and isostatic pressure for sufficiently long (e.g., a couple of hours) for appreciable diffusion of these constituents to take place. The diffusion bond may comprise a metal constituent (e.g., Zr, Al, Ti, Cr, Y, Er) of the receptacle 402 in solid solution within the body 102, or, vice versa. In the diffusion bond, there may be a dispersion of precipitates. The composition and the microstructure of the diffusion bond depends on the chemical composition of the receptacle and powdered material, and the HIPing conditions (time, temperature, and pressure). A diffusion bond generates a compositional gradient of the metal constituents present in the receptacle 402 within body 102. This compositional gradient increases monotonically from the fractional amount of that constituent in the body (i.e., the powdered material), which may be trace amounts (<0.01 wt %), to the fractional amount of that constituent in the receptacle 402.

In some examples, the compressive pressure is applied via hot isostatic pressing. Other methods suitable for achieving consolidation and sintering of the powdered material are known to the skilled reader.

In a specific example, the average temperature during step 306 is in the range 1000 to 1300C, more specifically 1100 to 1200C, even more specifically 1130 to 1170C; the average isostatic compressive pressure is 50 to 150 MPa, more specifically 75 to 125 MPa, even more specifically 90 to 110 MPa, and the predetermined period of time (at which that pressure and temperature is applied) is 3 to 5 hours, more specifically 3.5 to 4.5 hours, even more specifically 4 hours.

The skilled reader will understand that the values for temperature and pressure used in the treatment are, to an extent, interchangeable. For example, a comparatively higher pressure and lower temperature treatment may densify the metallic powder to an equivalent theoretical density compared with a treatment of comparatively lower pressure and higher temperature.

In some examples, steps 302 to 306 are replaced by additive manufacturing steps to generate a compositionally graded structure that comprises the body 102 (representing sintered powder from step 206) and “receptacle” layer 402 (as shown in FIG. 4), which are of differing composition. The use of additive manufacturing to produce compositionally graded structures is known, per se.

### Heat Treatments

In optional step 307, the receptacle 402 may be heated for a period of time to recrystallize the body 102 of the component. This recrystallization process eliminates prior-particle boundaries (PPBs) and a finer grain structure can be achieved, thereby improving the mechanical properties of the component 100.

Recrystallization is a process, whereby “high-energy” grains are replaced by a new set of “low-energy” grains that nucleate and grow at the expense of those “high-energy” grains. The “low-energy” grains are generally defect-free, whereas the “high energy” grains have defects or deformation (i.e., stored plastic energy), which provide the driving force for the recrystallization.

Recrystallization occurring during step 306 is advantageous because: it decreases the total concentration of defects in the body 102 of the component; and it eliminates prior particle boundaries (PPB).

PPBs are particularly common in components produced by hot isostatic pressing (HIP) and result from imperfect consolidation of the powdered material. The PPBs correspond to the boundaries of the powder particles before consolidation takes place. As the powdered materials often have an oxide coating, PPBs are correspondingly associated with oxides, which form weak links through the body 102 of the component 100, 200.

Further oxides and/or impurities may also segregate at the PPBs. These weak links reduce ductility significantly. Recrystallization advantageously removes these PPBs and hence avoids oxide and/or impurity segregation at those boundaries, thereby improving the mechanical properties (e.g., ductility) of the body 102.

The skilled reader will appreciate that plastic deformation induced in step 306, which may change the shape of the receptacle 402, can be modelled using software tools known to the skilled reader. The receptacle 402 may therefore be fabricated according to a shape that, following the plastic deformation in step 306, forms the desired shape component.

Step 307 can be performed concurrently with step 306. For example, using known hot isostatic pressing (HIP) machines (e.g., AVURE/Quintus technologies) that are capable of uniform rapid quenching (URQ) as well as heating. Heat treatments that cause recrystallization can therefore be carried out whilst powder consolidation takes place. This reduces manufacturing costs and means additional heat treatments, e.g., after the ceramic coating is formed in step 310 are not required.

In some examples, the receptacle 402 is completely transformed into ceramic coating 106, leaving no cladding layer 104 following step 308.

### Carrier Fluid

The carrier fluid may be a liquid or gas. Subjecting the ceramic coating 106 to the carrier fluid means providing these elements in the vicinity of the ceramic coating. Step 310 may include: flowing the carrier fluid over part or all of the ceramic coating 106, disposing the ceramic coating 106 in the carrier fluid, etc.

In an example, the carrier fluid is liquid lithium and the element it transports is calcium dissolved therein. If the metal oxide present in the ceramic coating after step 308 is iron oxide, then during step 308, the iron oxide present in the ceramic coating is replaced with calcium oxide deposits.

Example ceramic coatings, which as the skilled reader will appreciate are dependent on: i) the type of condition in step 308; ii) whether optional step 310 is performed; and iii) the composition of receptacle 402, include: aluminium oxide, titanium oxide, zirconia, yttrium oxide, zirconium carbide, titanium nitride, titanium carbide, erbium oxide, aluminium nitride etc.

### As Produced Component

Preferably, although not necessarily, the thickness of the receptacle following step 310 is greater than the thickness of the ceramic coating 106 that develops on its surface after step 308 and step 310. The difference in thickness defines the cladding layer 104. Typical values for the thickness of the receptacle, ceramic coating 106 and cladding layer 104 are around 1 to 2 mm (or 1 to 3 mm), 5-15 μm and 50-100 μm respectively. Other thickness values are, however, possible.

In some operating conditions, for example, where abrasion is prevalent, the ceramic coating 106 may spall or break, forming an area on the exterior surface of the component 100 without a ceramic coating 106. These areas may act as sites for accelerated corrosion, potentially of body 102, and hence are undesirable. By ensuring a cladding layer 104 is provided around the body 102, a “reservoir” of metallic constituents (e.g., Al, Ti, Zr, Cr), can be supplied in order to form a new ceramic coating 106, without incurring damage to the body 102.

The process of using a receptacle 402 to contain a metallic powder for densification is known to the skilled reader. Typically, however, the receptacle 402 of the prior art used to contain the powder is removed altogether following consolidation in step 306 (e.g., by pickling). It does not form part of the fabricated component. Conversely, in the proposed method, at least part of the receptacle 402 forms an integral part of the component 100—the cladding layer 104, and/or is used to form the ceramic coating. As the receptacle forms part of the produced component, subtractive manufacturing processes, which are wasteful in terms of material, cost and time, can be avoided.

### Vanadium

The method of FIG. 3 is particularly advantageous for producing components having a body comprising a vanadium alloy, for example a V—Cr—Ti alloy (e.g., V-4Cr-4Ti wt %), V—Cr—Ti—Y alloy (e.g., V-4Cr-4Ti-0.2Y wt %) or oxide dispersion strengthened (ODS) vanadium alloy.

This is because, conventionally, vanadium alloys are prepared by a complicated process, which includes: ingot casting, hot forging, hot or cold rolling, followed by a heat treatment at temperatures greater than 700° C. Unavoidable impurities of carbon, oxygen, nitrogen present in the melt precipitate out in the alloy as Ti—CON, which provide strengthening up until their dissolution temperature (~1000° C.). Another challenge with melt processing is that vanadium has a high solid solubility limit for oxygen and nitrogen (e.g., 2.7 wt % and 1.7 wt %, respectively, at 1000° C.). As oxygen and nitrogen are difficult to exclude, solid solution strengthening is, to an extent, unavoidable, which, at such high levels (e.g., 2.7 wt % and 1.7 wt %, as above), results in an undesirable reduction in ductility. Small amounts of yttrium (<0.2 wt %), which scavenge oxygen and form Y₂O₃ precipitates (i.e., oxide dispersion strengthened vanadium alloy; ODS-vanadium alloy), can be added to the vanadium alloy during melting, but homogeneously distributing these the Y₂O₃ precipitates in the microstructure, which leads to improved mechanical properties, is a challenge.

Whilst mechanical (MA) alloying of elemental powders (i.e., vanadium, chromium, titanium, yttrium (and possibly, TiC particles) in a ball mill) and consolidating by hot extrusion or hot isostatic pressing (HIPing) is an alternative processing route, it is energy intensive and has poor scalability.

Referring back to the method of FIG. 3, the powdered material may be a V—Cr—Ti—Y pre-alloyed powder produced by inert gas atomisation (e.g., in nitrogen or argon). The composition may be 4-5 wt % Cr, 4-5 wt % Ti, <0.2 wt % Y, V (balance).

If nitrogen gas is used as the inert gas for atomisation, some nitrogen will be dissolved interstitially in solid solution within the powder. Some nitrogen may precipitate out in the form of nitride precipitates. As oxygen is present as an impurity in nitrogen gas and it is difficult to exclude oxygen altogether during storage of the powder, the pre-alloyed powder may also have an oxide layer on its surface. The oxide may be chromium oxide, titanium oxide, vanadium oxide, yttrium oxide or a combination thereof. The pre-alloyed powder may also include oxygen dissolved in solid solution (interstitially) within the alloy. In some examples, the oxygen may also bind preferentially with the alloying elements (Cr, Ti, Y) to form discrete oxide particles (<1 μm). In summary, the powdered material may comprise oxide and nitride particles internally disposed within the powder, an oxide layer on the powder surface, and oxygen and nitrogen dissolved interstitially in solid solution within the powder.

As has already been noted, dynamic recrystallization of vanadium alloys during consolidation in step 306 is possible if the packing density of the powdered vanadium is sufficiently low (e.g., less than 75%, more specifically less than 70% which are typical values for narrow powder size distributions).

It has also been found that, where yttrium is present in the pre-alloyed powdered material, further improvements in mechanical properties (e.g., ductility, toughness and strength) of the body 102 are possible during dynamic recrystallization. Specifically, yttrium in solid solution in the powdered material scavenges any “free” oxygen that develops as prior oxides present in the powder are reduced at the elevated temperatures during consolidation in step 306. The yttrium forms yttrium oxide. During recrystallization, the grain boundaries move and carry the yttrium oxides with them, distributing the yttrium oxides homogenously within the body 102 in the process. This homogeneous distribution of fine yttrium oxides leads to the synergistic improvement in mechanical properties.

Vanadium alloys and in particular V-4Cr-4Ti (wt %) and ODS V-4Cr-4Ti (wt %), which have been mentioned above, are promising candidates for the structural components of a breeder blanket in a tokamak or a spherical tokamak. The exact composition of the alloy is guided by the desired end properties, such as creep resistance and oxidation resistance. A relatively larger Chromium content and relatively smaller Vanadium content may therefore be desirable in some cases (i.e., to improve creep and oxidation resistance), or a V—Cr—Zi alloy may be preferred to a V—Cr—Ti alloy. Advantages of such alloys include:
Low induced (neutron and gamma) activation characteristics;
High resistance to neutron radiation damage;
High strength at expected operating temperature window of around 400° C.-700° C.;
Excellent compatibility with liquid lithium; and
their use does not directly affect magnetic plasma confinement because they are not ferromagnetic.

### Magnetic Confinement Plasma Chambers

The method of FIG. 3 is particularly suited to producing structural components for a magnetic confinement plasma chamber, for example, a tokamak, preferably a spherical tokamak. Preferably, but not necessarily, the aspect ratio of the spherical tokamak is less than or equal to 2.5. The aspect ratio is the ratio of the major and minor radii of the toroidal plasma-confining regions of the tokamak. More particularly, the method of FIG. 3 is suitable for producing structural components in a tritium breeder blanket in a tokamak or spherical tokamak.

As has already been mentioned, tritium-breeder blankets include a lithium-containing element, which may be solid (e.g., a lithium compound), or liquid (e.g., liquid lithium, lithium-lead eutectic, or a molten salt).

The inventors have realised that the ceramic coating 106 of component may be formed, or repaired, in-situ in the presence of a carrier fluid (e.g., liquid lithium, Li—Pb eutectic, H—He gas mixture) in a breeder blanket. This corresponds to step 310 in FIG. 3.

As the oxygen potential in lithium is low (~−500 kJ/mole), most oxide coatings in the ceramic coating 106 are unstable and are vulnerable to dissolution in the presence of a carrier fluid comprising lithium. This is undesirable. To avoid dissolution of the ceramic coating 106, it is proposed that oxide-forming additives (e.g., erbium, yttrium, or calcium) are added to the carrier fluid. The additives form stable oxides, even in the presence of the carrier fluid containing lithium. Erbium oxide, yttria and calcium oxide are particularly beneficial as: they are stable in liquid lithium at normal operating conditions (i.e., temperatures up to 700° C.), they possess high electrical resistivity, and they have high resistance to tritium permeation.

By controlling the flow rate of the carrier fluid, the concentration of additives in the carrier fluid, the temperature and/or pressure of the carrier fluid, the oxides in the ceramic coating 106 formed in step 208 can be reduced and replaced with more stable oxides. Example conditions include: erbium, yttrium and/or calcium at a concentration between 5 wt % and 10 wt % at a temperature below 600C. A ceramic coating comprising these stable oxides would otherwise be difficult to achieve because it is unpractical to fabricate a receptacle from those elements (i.e., erbium, calcium or yttrium) due to their high affinity for oxygen.

If the carrier fluid does not include lithium, it is proposed that carbon, nitrogen or oxygen containing gaseous molecules (e.g., nitrogen, carbon dioxide, carbon monoxide, water vapour, oxygen, nitrogen oxide etc.) are added (e.g., dissolved, suspended) to the carrier fluid, such that, if the ceramic coating 106 is compromised (e.g., by abrasion, erosion or the like), the cladding layer 104 reacts spontaneously with those gaseous molecules to repair the ceramic coating 106. In this regard, the presence of a cladding layer 104 is advantageous in providing a self-healing effect in use. Example carrier fluids include: a helium-hydrogen mixture, liquid lithium, lithium-lead eutectic and molten lithium salt.

### Example Systems

Solid Lithium Breeders: Lithium-Containing Ceramic (Li₂TiO₃, Li₄SiO₄ or a Mixture Thereof)

In a specific example, the component 100, 200 is used in a lithium-containing ceramic breeder blanket, e.g., as a structural component. The component 100, 200 includes a body 102 formed from a steel, preferably oxide dispersed strengthened (ODS) steel or a reduced activation ferritic/martensitic (RAF/M) steel, such as Eurofer-97 (herein Eurofer) or F82H steel, a cladding layer 104 comprising an alloy containing aluminium and a ceramic coating comprising aluminium oxide. The (i) receptacle 402 and (ii) powdered material 404 in the method of FIG. 3 are therefore respectively: (i) an aluminium containing alloy (e.g., FeCrAl alloy); and (ii) ODS steel or a RAF/M steel. The ceramic coating can be formed in step 308 via an oxidising treatment or alternatively using a carrier fluid via step 310. The carrier fluid is a gas mixture of helium and hydrogen which is supplied through the lithium ceramic pebble bed and which transports water vapour. The supply of a helium-hydrogen gas mixture (but without water vapour) to the pebble bed is known to the skilled reader and is the basis for tritium extraction. By varying the flow rate of the helium-hydrogen mixture, the concentration of water vapour, the temperature and/or pressure, the conditions of the breeder blanket can be controlled such that it is energetically favourable for the cladding layer 104 to oxidise to form aluminium oxide. This ability to form the ceramic layer 106 in-situ is advantageous because should the ceramic coating 106 be compromised (e.g., via abrasion, erosion or the like), the coating 106 can be spontaneously replenished by oxidation of the cladding layer 104. Damage to underlying components of the system is therefore mitigated.

Unless expressly stated to the contrary, a steel includes one or more of the following phase constituents: austenite, ferrite, martensite, bainite; and includes precipitates or particles dispersed within these one or more constituents. For example, carbides, nitrides and oxides. Example steels include a ferritic/martensitic steels (e.g., Eurofer-97, a cast nanostructured alloy), austenitic stainless steels (e.g., 316L), ferritic steels, or an oxide dispersed strengthened (ODS) steel (both ferritic and ferritic/martensitic).

The composition of Eurofer-97 is <0.01 wt % aluminium, <0.01 wt % nickel, <0.02 wt % titanium, 0.015-0.045 wt % nitrogen, <0.01 wt % cobalt, <0.01 wt % oxygen, <0.05 wt % silicon, 0.15-0.25 wt % vanadium, 8.50-9.50 wt % chromium, 0.20-0.60 wt % manganese, 0.10-0.14 wt % tantalum, 1.0-1.2 wt % tungsten, <0.01 wt % copper, 0.090-0.120 wt % carbon and <0.072 wt % other impurities including phosphorus, sulphur, molybdenum, niobium, boron, arsenic, tin, antimony and zirconium, balance iron.

The composition of F82H is iron (balance), 0.098 wt % carbon, 7.81 wt % (~8 wt %) chromium, 1.88 wt % (~2 wt %) tungsten, 0.44 wt % manganese, 0.19 wt % vanadium, 0.037 wt % tantalum.

The ODS steel may be ferritic (with 9-16 wt % Cr) or martensitic (with 8-9 wt % Cr), as a pre-alloyed powdered material 404. Example compositions include: 9Cr-0.13C-0.2Ti-2W-0.35Y₂O₃, 13Cr-0.02C-3W-0.7Ti-0.46Y₂O₃, 13Cr-0.05C-3W-0.5Ti-0.34Y₂O₃, 11Cr-0.09C-3W-0.4Ti-0.66Y₂O₃ (all compositions in wt % and the balance being iron).

These compositional details of steels apply vis-à-vis the remaining breeder blanket type examples and are not repeated for conciseness.

### Breeder Blanket Type—Pb—Li Eutectic (14-17at % Li)

In a specific example, the component 100, 200 is used in a lithium-lead eutectic breeder blanket, e.g., as a structural component. The component 100, 200 includes a body 102 formed from a steel, preferably an oxide dispersed strengthened (ODS) steel or a RAF/M steel, such as Eurofer, a cladding layer 104 comprising an FeCrAl alloy (e.g., 20-30 wt % Cr, 4-7.5 wt % Al, Fe balance) and a ceramic coating comprising aluminium oxide. The (i) receptacle 402 and (ii) powdered material 404 in the method of FIG. 3 are therefore respectively: (i) FeCrAl alloy; and (ii) ODS steel or RAF/M steel. The ceramic coating can be formed in step 308 via an oxidising treatment or alternatively using a carrier fluid via step 310. The carrier fluid is the lithium-lead eutectic, which contains dissolved oxygen therein. The concentration of oxygen in the lithium-lead eutectic and/or the rate of replenishment (e.g. flow rate) of the lithium-lead eutectic over the component 100, 200 can be controlled to ensure that sufficient dissolved oxygen is present to form or replenish the aluminium oxide ceramic coating. As above, the ability to form the ceramic layer 106 in-situ is advantageous because if the ceramic coating 106 is compromised (e.g., via abrasion, erosion or the like), the coating 106 is spontaneously replenished by oxidation of the cladding layer 104. Damage to underlying components of the system is therefore mitigated.

### Breeder Blanket Type—Liquid Lithium

In a specific example, the component 100, 200 is used in a liquid lithium breeder blanket, e.g., as a structural component.

The component 100, 200 may include a body 102 formed from a vanadium alloy (e.g., containing 4-5 wt % Cr, 4-5 wt % Ti, balance V), a cladding layer 104 comprising an FeCrAl alloy (e.g., 20-30 wt % Cr, 4-7.5 wt % Al, Fe balance) or Fe-containing alloy (e.g., substantially pure iron). The ceramic coating 106 is initially iron oxide and/or aluminium oxide (e.g., formed during an oxidising treatment in step 308). However, in operation in the breeder blanket, the ceramic coating 106 comprises Er₂O₃, Y₂O₃ and/or CaO. In particular, these oxides are generated in-situ by reducing the iron oxide and/or aluminium oxides present in the ceramic coating 106 formed in step 308. This can be achieved by dissolving between 5 and 10 wt % erbium, yttrium and/or calcium in the liquid lithium at a temperature of 500 to 600° C. The oxide coatings can therefore be replenished in situ during operation, which is advantageous.

The component 100, 200 may instead include a body 102 formed from a vanadium alloy (e.g., containing 4-5 wt % Cr, 4-5 wt % Ti, balance V with less than 1 wt %, more preferably less than 0.2 wt % yttrium as a pre-alloyed powder), a cladding layer 104 comprising an FeCrAl alloy (e.g., 20-30 wt % Cr, 4-7.5 wt % Al, Fe balance) or Ti-containing alloy (e.g., substantially pure titanium, 5-10 wt % Fe—Ti). Yttrium is effective at removing oxygen from solid solution within the vanadium alloy, thereby improving its ductility. This scavenging property of yttrium has been described above. The powdered material 404 may therefore include <1 wt % yttrium in pre-alloyed powder form. The ceramic coating 106 comprises titanium and/or aluminium nitride (e.g., formed during a nitridising treatment in step 308 or alternatively using a carrier fluid via step 310). The carrier fluid is liquid lithium, containing dissolved nitrogen therein. The concentration of nitrogen in the liquid lithium and the flow rate of the liquid lithium over the component 100, 200 can be controlled to ensure that sufficient dissolved nitrogen is present to form or replenish the titanium and/or aluminium nitride ceramic coating. As above, the ability to form the ceramic layer 106 in-situ is advantageous because if the ceramic coating 106 is compromised (e.g., via abrasion, erosion or the like), the coating 106 is spontaneously replenished by oxidation of the cladding layer 104. Damage to underlying components of the system is therefore mitigated.

The component 100, 200 may instead include a body 102 formed from a steel, preferably Eurofer or ODS steel, and a cladding layer 104 comprising an FeCrAl alloy (e.g., 20-30 wt % Cr, 4-7.5 wt % Al, Fe balance) or Ti-containing alloy (e.g., substantially pure titanium, 5-10 wt % Fe—Ti). The ceramic coating 106 comprises titanium and/or aluminium nitride (e.g., formed during an nitridising treatment in step 308 or alternatively using a carrier fluid via step 310). The carrier fluid is liquid lithium, containing dissolved nitrogen therein. The concentration of nitrogen in the liquid lithium and the flow rate of the liquid lithium over the component 100, 200 can be controlled to ensure that sufficient dissolved nitrogen is present to form or replenish the titanium and/or aluminium nitride ceramic coating. As above, the ability to form the ceramic layer 106 in-situ is advantageous because if the ceramic coating 106 is compromised (e.g., via abrasion, erosion or the like), the coating 106 is spontaneously replenished by oxidation of the cladding layer 104. Damage to underlying components of the system is therefore mitigated.

The component 100, 200 may instead include a body 102 formed from a steel, preferably Eurofer or ODS steel and a cladding layer 104 comprising an FeCrAl alloy (e.g., 20-30 wt % Cr, 4-7.5 wt % Al, Fe balance) or Fe-containing alloy (e.g., substantially pure iron). The ceramic coating 106 is initially iron oxide and/or aluminium oxide (e.g., formed during an oxidising treatment in step 308). However, in operation in the breeder blanket, the ceramic coating 106 comprises Er₂O₃, Y₂O₃ and/or CaO. In particular, these oxides are generated in-situ by reducing the iron oxide and/or aluminium oxides present in the ceramic coating 106 formed in step 308. This can be achieved by dissolving between 5 and 10 wt % erbium, yttrium and/or calcium in the liquid lithium at a temperature of 500 to 600° C. The oxide coatings can therefore be replenished in situ during operation, which is advantageous.

### Breeder Blanket Type—Molten Lithium Salt (e.g., FLiBe)

In a specific example, the component 100, 200 is used in a molten lithium salt breeder blanket, e.g., as a structural component. The component 100, 200 includes a body 102 formed from a steel, preferably a oxide dispersed strengthened (ODS) steel or Eurofer steel, a cladding layer 104 comprising an FeCrAl alloy (e.g., 20-30 wt % Cr, 4-7.5 wt % Al, Fe balance) and a ceramic coating comprising aluminium oxide. The (i) receptacle 402 and (ii) powdered material 404 in the method of FIG. 3 are therefore respectively: (i) a FeCrAl alloy and (ii) a steel, e.g., ODS steel or Eurofer steel. The ceramic coating can be formed in step 308 via an oxidising treatment.

The example systems are summarised in Table 1 below.

TABLE 1

| | | Receptacle | Ceramic | |
|---|---|---|---|---|
| Breeder | Powder 404 | 402 or | coating | How is the ceramic |
| type | or Body 102 | Cladding 104 | 106 | coating formed? |
| Li | A steel, e.g., | Al alloy e.g., | Aluminium | Oxidation of Al-containing |
| ceramic | ODS, a | FeCrAl | oxide | cladding. This may be via |
| | RAFM/steel, | | | oxidizing treatment (step |
| | Eurofer, F82H | | | 308) or in-situ using a |
| | | | | carrier fluid of H-He |
| | | | | carrying water vapour. |
| Pb-Li | A steel, e.g., | FeCrAl | Aluminium | Oxidation of Al-containing |
| eutectic | ODS a RAF/M | | oxide | cladding. This may be via |
| | steel, Eurofer | | | oxidizing treatment (step |
| | | | | 308) or in-situ using Pb-Li |
| | | | | eutectic with oxygen |
| | | | | dissolved therein. |
| Liquid | Vanadium | FeCrAl, Fe | Er₂O₃, | In-situ reduction of iron |
| lithium | alloy | alloy (e.g., | Y₂O₃, CaO | oxide formed in step 308 |
| | | substantially | | using Er, Y and/or Ca |
| | | pure Fe) | | dissolved in liquid lithium |
| | | | | as a carrier fluid in step |
| | | | | 310. |
| Liquid | Vanadium | Ti alloy | TiN, AlN | Nitridising of titanium or |
| lithium | alloy with | (substantially | | aluminium containing |
| | yttrium/yttria | pure Ti or 5- | | cladding. This may be via |
| | | 10 wt % Fe-Ti | | nitridising treatment (step |
| | | alloy) or | | 308) or in-situ using liquid |
| | | FeCrAl | | lithium with nitrogen |
| | | | | dissolved therein. |
| Liquid | A steel, e.g., | Ti alloy | TiN, AlN | Nitridising of titanium or |
| lithium | ODS, a | (substantially | | aluminium containing |
| | RAF/M steel, | pure Ti or 5- | | cladding. This may be via |
| | Eurofer | 10 wt % Fe-Ti | | nitridising treatment (step |
| | | alloy) or | | 308) or in-situ using liquid |
| | | FeCrAl | | lithium with nitrogen |
| | | | | dissolved therein. |
| Liquid | A steel, e.g., | Fe alloy (e.g., | Er₂O₃, | In-situ reduction of iron |
| lithium | ODS, a | substantially | Y₂O₃, CaO | oxide formed in step 308 |
| | RAF/M steel, | pure Fe) or | | using Er, Y and/or Ca |
| | Eurofer | FeCrAl | | dissolved in liquid lithium |
| | | | | as a carrier fluid in step |
| | | | | 310. |
| Lithium | A steel, e.g., | FeCrAl | Aluminium | Oxidation of FeCrAl |
| molten | ODS, a | | oxide | cladding. This may be via |
| salt | RAF/M steel, | | | oxidizing treatment (step |
| | Eurofer | | | 308) |

More generally, therefore the cladding 106 of the component comprises any one or more of: Fe, Cr, Al, Ti, and optionally Zr. The weight fraction of Al and Ti being sufficiently high to enable the formation of ceramic coating 106 (e.g., AlN, Al₂O₃, TiN) in step 308. The powdered material 404, which constitutes the body 102 of the component after consolidation, is a steel, a vanadium alloy or conventional nickel based alloy.

Conventionally, a corrosion-resistance nickel-based alloy (e.g., Hastelloy™) is used as the structural component in the tokamak, e.g., for a lithium molten salt, FLiBe, type breeder blanket. However, under neutron irradiation, nickel based alloys develop high activation levels which is undesirable from nuclear waste management point of view. The proposed method of developing a protective barrier coating 106 on the body 102 of the structural component allows use of lower activation structural alloys (e.g., Eurofer97, ODS-steel, vanadium alloy) in corrosive environments which they were otherwise unsuitable for.

Other uses for the component 100, 200 include: replacing refractory metals (e.g., tungsten) in a tokamak divertor with ceramic-coated non-refractory metals (e.g., steels); heat exchanger elements, in particular for a gas-cooled reactor; tritium permeation barrier in molten salt fission reactors (e.g., fluoride salt cooled high-temperature nuclear reactor); high performance structural components (using 4-5 wt % Cr, 4-5 wt % Ti, <0.2 wt % Y and V (balance)) in Gen-IV reactors, and even hydrogen storage technologies since the ceramic coating 106 is effective at protecting body 102 against hydrogen embrittlement.

Although the invention has been described in terms of preferred embodiments, as set forth above, it should be understood that these embodiments are illustrative only and that the claims are not limited to those embodiments. Features from different examples may be combined as appropriate to form other working examples.

1. A method of producing a component, wherein the component comprises a body and a ceramic coating, the method comprising:
at least partially filling a receptacle with a powdered material;
subjecting the receptacle to compressive pressure at a temperature and for a period of time sufficient to at least partially consolidate said powdered material to form the body of the component; and
subjecting the receptacle to oxidising conditions, nitridising conditions and/or carburising conditions and thereby transforming an external surface of the receptacle into the ceramic coating.

2. The method according to claim 1, wherein the thickness of the ceramic coating is less than the thickness of the receptacle.

3. The method according to claim 1, further comprising a cladding layer between the body and the ceramic coating.

4. The method according to claim 1, wherein the thickness of the receptacle is around 1 mm to 3 mm and the thickness of the ceramic coating is around 5 to 15 μm.

5. The method according to claim 1, wherein the step of subjecting the receptacle to oxidising conditions, nitridising conditions and/or carburising conditions comprises subjecting the receptacle to carburising conditions such that the ceramic coating comprises a carbide of a metallic constituent present in the composition of the receptacle.

6. (canceled)

7. The method according to claim 1, wherein the ceramic coating comprises a metal oxide, further comprising a step of:
providing one or more elements, having a higher affinity for oxygen than a metal of the metal oxide, in the vicinity of said ceramic coating by:
subjecting the ceramic coating to a carrier fluid comprising said one or more elements, whereby said step replaces said metal oxide in the ceramic coating with an oxide of said one or more elements.

8. (canceled)

9. The method according to claim 1, wherein the packing density of the powdered material in the receptacle is less than 70%.

10. The method according to claim 9, wherein the size distribution of the powdered material is unimodal.

11. The method according to claim 1, wherein the compressive pressure is isostatic, and the average isostatic pressure is in the range 50 to 150 MPa, the average temperature is in the range 1000 to 1300° C. and the period of time at said temperature and said pressure is in the range of 3 to 5 hours.

12. The method according to claim 11, wherein said average isostatic pressure, average temperature and period of time results in dynamic grain recrystallization of the powdered material.

13. (canceled)

14. The method according to claim 12, wherein the powdered material is a pre-alloyed powder comprising an alloy of vanadium with chromium and at least one of titanium or zirconium.

15. The method according to claim 1, wherein the powdered material comprises any one of: ODS-steel, austenitic stainless steel or a reduced activation ferritic/martensitic steel.

16. The method according to claim 1, wherein the receptacle comprises any one or more of: iron, chromium, aluminium, titanium, zirconium or an alloy thereof.

17-27. (canceled)

28. A method of producing a component having a ceramic coating, the method comprising:
at least partially filling a receptacle with a powdered material;
subjecting the powdered material to compressive pressure at a temperature and for a period of time sufficient to at least partially consolidate said powdered material to form a body of the component; and
transforming an external surface of the receptacle into a ceramic coating such that an untransformed layer of the receptacle remains between the body of the component and the ceramic coating.
